(19) United States
(12) Patent Application Publication
(10) Pub. No.: US 2006/0098986 A1
(43) Pub. Date: May 11, 2006

(54) Optical receiver for reducing optical beat interference and optical network including the optical receiver

(76) Inventors: Eui Suk Jung, Seo-gu (KR); Byoung Whi Kim, Yusong-gu (KR); Yong Yuk Won, Seodaemoon-gu (KR); Sang Kook Han, Seodaemoon-gu (KR); Hyun Do Jung, Seodaemoon-gu (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/099,180

(22) Filed: Mar. 30, 2005

(30) Foreign Application Priority Data
Nov. 10, 2004 (KR) 10-2004-91426
Dec. 10, 2004 (KR) 10-2004-104355

(51) Int. Cl. H04B 10/00

(52) U.S. Cl. 398/140

(57) ABSTRACT

An optical receiver for use in an Optical Network (ON) such as a WPON based on an SCMA scheme. The optical receiver apparatus for use in a Central Office contained in an ON includes: an optical power divider for dividing an input optical signal into first and second optical signals; a frequency generator for generating a oscillation frequency; a phase shifter for shifting a phase of the oscillation frequency; a first optical modulator for modulating the first optical signal with the oscillation frequency; a second optical modulator for modulating the second optical signal with the oscillation frequency phase-shifted; a first photodiode for converting the optical signal modulated by the first optical modulator into a first RF signal; a second photodiode for converting the optical signal modulated by the second optical modulator into a second RF signal; and a differential amplifier for differentially amplifying the first RF signal and the second RF signal.

### RELATED APPLICATION

The present application is based on, and claims priority from Korean Application Number 2004-91426, filed Nov. 10, 2004, and Korean Application Number 2004-104355, filed Dec. 10, 2004, the disclosure of which is incorporated by reference herein in its entirety.

### BACKGROUND OF THE INVENTION

1. Field of the Invention

The present invention relates to an optical receiver for use in an Optical Network (ON) such as a Wavelength Division Multiplexing Passive Optical Network (WPON or WDM-PON) based on a Sub-Carrier Multiple Access (SCMA) scheme, and more particularly to an optical receiver for reducing optical beat interference (i.e., optical interference noise) and an optical network (ON) including the same, which allow a Central Office (CO) for use in an SCMA-based optical network to remove optical beat interference generated when detecting a multiple light source signal by inverting a signal phase or using a differential amplifier, such that the CO can efficiently remove the optical beat interference, resulting in greater convenience of maintenance and management of the optical network (ON).

2. Description of the Related Art

Recently, the most important technology associated with an optical network (ON) has been considered to be a cost-effective and high-productivity optical transmission scheme according to characteristics of a subscriber network, such that a variety of improved technologies capable of implementing low-priced optical components and accommodating a plurality of subscribers are required to develop the above-mentioned transmission scheme. A representative method for implementing the above-mentioned cost-effective optical communication system allows a plurality of subscribers to share one wavelength, such that it increases the number of subscribers contained in a given wavelength band.

In this case, a representative method for increasing the number of subscribers is indicative of a Sub-Carrier Multiplexing (SCM) scheme. The SCM scheme assigns different sub-carriers to light sources of individual subscribers sharing a wavelength, includes necessary information in the sub-carriers assigned to individual subscribers, and transmits the sub-carriers including the necessary information to a reception end. The reception end recognizes a desired signal using a band pass filter (BPF) associated with a subscriber such that it can distinguish among a variety of subscriber information.

A representative example of the above-mentioned conventional SCMA optical communication system will hereinafter be described with reference to FIG. 1.

FIG. 1 is a block diagram illustrating a conventional SCMA-optical network (ON) system.

Referring to FIG. 1, the conventional SCMA-ON system includes: a plurality of subscriber ends 10-1 to 10-N including a plurality of optical transceivers 11-1 to 11-N capable of transmitting optical signals using a single wavelength, respectively; an Optical Coupler (OC) 20 for coupling the optical signals transmitted from the optical transceivers 11-1 to 11-N of the subscriber ends 10-1 to 10-N to a single optical fiber; a telephone office Optical Line Terminal (OLT) 30 connected to the OC via the optical fiber such that it transmits an optical signal; and a Central Office (CO) 40 including an optical transceiver 41 capable of receiving the optical signal from the telephone office OLT 30.

In this case, the optical transceiver includes an optical transmitter 41a, an optical receiver 41b, and an optical coupler 41c.

As shown in FIG. 1, although the ON uses the same wavelength in the range from individual subscriber ends 10-1 to 10-N to the OC 20, it includes information in different sub-carriers and transmits the sub-carriers including the information. Therefore, a plurality of subscribers can share a single wavelength using the SCMA scheme shown in FIG. 1, such that network construction costs are reduced and a low-priced optical subscriber network (also called a low-priced optical network) is implemented.

A representative example of optical receivers contained in the conventional CO shown in FIG. 1 is shown in FIG. 2.

FIG. 2 is a schematic diagram illustrating an optical receiver contained in the CO shown in FIG. 1.

Referring to FIG. 2, the optical receiver is indicative of a photo diode for converting an optical signal received via an optical fiber into an electric signal.

In recent times, in order to effectively use a wide bandwidth of an optical network (ON), an SCMA-ON system based on a WDMN scheme has been increasingly researched due to use of backbone- and subscriber-networks. However, in the case where a single optical receiver contained in an CO for use in an SCMA-ON system for transmitting a multi-channel RF signal using a multiple light source simultaneously receives at least two light sources from a plurality of subscriber ends, it is well known in the art that optical beat interference occurs when an optical signal is converted into an electric signal. The optical beat interference deteriorates a signal-to-noise ratio (SNR) and a subcarrier-to-noise ratio of the system, such that it has a negative influence upon overall system performance.

Due to the above-mentioned problem, a new method for reducing the optical beat interference in the SCMA-ON system must be developed. Provided that signal transmission of a real link is not stable due to the optical beat interference generated during the ON implementation process, the development of other technologies based on stable signal transmission of the real link is unavoidably affected or is postponed. At present, advanced countries have conducted intensive research into technologies associated with stable signal transmission of an optical transmission link.

Under the above-mentioned situations, optical beat interference reduction technologies are necessary to implement an optical network (ON) using WDM and SCMA schemes.

The conventional optical beat interference reduction technologies will hereinafter be described with reference to FIGS. 3 and 4.

FIG. 3 is a block diagram illustrating the conventional optical beat interference reduction apparatus using a dithering signal and an optical frequency modulator. Referring to FIG. 3, an optical signal generated from a laser diode 42A contained in the optical beat interference reduction apparatus using the dithering signal and the optical frequency modulator is modulated by a radio frequency (RF) signal generated from a signal modulator 42B. An optical frequency modulator 42C performs spread spectrum modulation on the modulated optical signal using the dithering signal, such that the optical signal spectrum bandwidth is widely spread. The optical beat interference generated in the widely-spread bandwidth is distributed, such that the intensity of the optical beat interference is reduced and associated negative influence is also reduced.

A representative example of the above-mentioned optical beat interference reduction apparatus has been described in U.S. Pat. No. 5,798,858.

However, the above-mentioned conventional optical beat interference reduction apparatus has a disadvantage in that non-linear signal distortion occurs when a signal is transitioned from a maximum value to a minimum value. Also, the conventional optical beat interference reduction apparatus has another disadvantage in that it must use high-priced optical components, such as an optical frequency modulator and/or an optical phase modulator, resulting in increased production costs.

FIG. 4 is a block diagram illustrating an optical beat interference reduction apparatus using a level shifted signal modulation (LSM) technique.

Referring to FIG. 4, the optical beat interference reduction apparatus using the conventional LSM technique modulates a signal modulated by a signal modulator 44A into a level shift signal using a level shift modulator (LSM) 44B, converts the resultant LSM signal into an optical signal using a laser diode 44C, and transmits the optical signal to an optical fiber.

In this case, the level shift modulation (LSM) scheme is indicative of a method for re-forming waveforms of an RF signal to prevent the occurrence of non-linear distortion when a modulation index of the RF signal is increased by multiplying an RF sub-carrier signal transitioned to a DC level by a DC-component additional signal. The above-mentioned optical beat interference reduction technologies do not suffer from chirping whereas they increase the modulation index of the RF signal, such that non-linear distortion does not occur in the optical beat interference reduction apparatus.

However, provided that a multi-channel RF signal must be transmitted, the above-mentioned optical beat interference reduction apparatus must consider signal interference associated with neighboring RF signals, such that its design and implementation is complicated. Also, the optical beat interference reduction apparatus must further use an additional RF signal, such that it must further use a supplementary circuit associated with the additional RF signal.

In the meantime, one of other optical beat interference reduction technologies other than the above-mentioned optical beat interference reduction technology is an optical beat interference reduction technique for use with a laser beam operated in a burst mode. The above-mentioned optical beat interference reduction technique operates subscribers' light sources received in a receiver, quickly transmits information to be transmitted when the information to be transmitted is present, and quickly reduces a power level of a laser beam when the information to be transmitted is not present. The optical beat interference reduction technique can prevent the occurrence of optical beat interference generated when an optical power received in a receiver beats other light sources on the condition that a subscriber does not transmit information.

However, in order to operate an optical transmitter in the burst mode, the above-mentioned optical beat interference reduction technique must monitor both a modulation signal acting as a carrier and optical power information using baseband information and a carrier, which have occurred prior to a modulation operation of the optical transmitter of a subscriber, such that it must control a bias current of a laser beam to adapt to the burst mode.

The above-mentioned conventional method prevents optical beat interference (OBI) from being generated by minimizing the number of light sources received at the same time. However, if the beat interference is continuously generated in a receiver due to a large amount of data to be transmitted by individual light sources, it is difficult for information to be transmitted at a desired quality.

### SUMMARY OF THE INVENTION

Therefore, the present invention has been made in view of the above problems, and it is an object of the present invention to provide an optical receiver for allowing a Central Office (CO) for use in an Optical Network (ON) such as a Wavelength Division Multiplexing Passive Optical Network (WPON or WDM-PON) based on a Sub-Carrier Multiple Access (SCMA) scheme to remove optical beat interference generated when detecting a multiple light source signal by inverting a signal phase or using a differential amplifier, such that the CO can efficiently remove the optical beat interference, resulting in greater convenience of maintenance and management of the ON.

It is another object of the present invention to provide an ON including an optical receiver capable for removing optical beat interference generated when detecting a multiple light source signal by inverting a signal phase or using a differential amplifier.

In accordance with the present invention, the above and other objects can be accomplished by the provision of an optical receiver apparatus for use in a Central Office (CO) contained in an Optical Network (ON), comprising: an optical power divider for dividing an input optical signal into first and second optical signals; a frequency generator for generating a predetermined oscillation frequency; a phase shifter for shifting a phase of an oscillation frequency generated by the frequency generator; a first optical modulator for modulating the first optical signal with the oscillation frequency generated by the frequency generator; a second optical modulator for modulating the second optical signal with the oscillation frequency phase-shifted by the phase shifter; a first photodiode for converting the optical signal modulated by the first optical modulator into an RF signal; a second photodiode for converting the optical signal modulated by the second optical modulator into an RF signal; and a differential amplifier for differentially amplifying the RF signal generated by the first photodiode and the RF signal generated by the second photodiode, and canceling two optical beat interferences having the same phase, contained in each of the RF signals.

Preferably, the length of an optical signal transmission channel from the optical power divider to the first photodiode may be equal to the length of the other optical signal transmission channel from the optical power divider to the second photodiode.

Preferably, the first photodiode and the second photodiode may have the same characteristics.

The present invention provides an ON which contains a CO including the optical receiver.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional SCMA-ON system;

FIG. 2 is a schematic diagram illustrating an optical receiver contained in a CO shown in FIG. 1;

FIG. 3 is a block diagram illustrating a conventional optical beat interference reduction apparatus using a dithering signal and an optical frequency modulator;

FIG. 4 is a block diagram illustrating an optical beat interference reduction apparatus using an LSM technique;

FIG. 5 is a block diagram illustrating an optical receiver in accordance with the present invention;

FIG. 6 is a view illustrating spectrums of the principal signals shown in FIG. 5 in accordance with the present invention; and

FIG. 7 is a block diagram illustrating an ON including the optical receiver in accordance with the present invention.

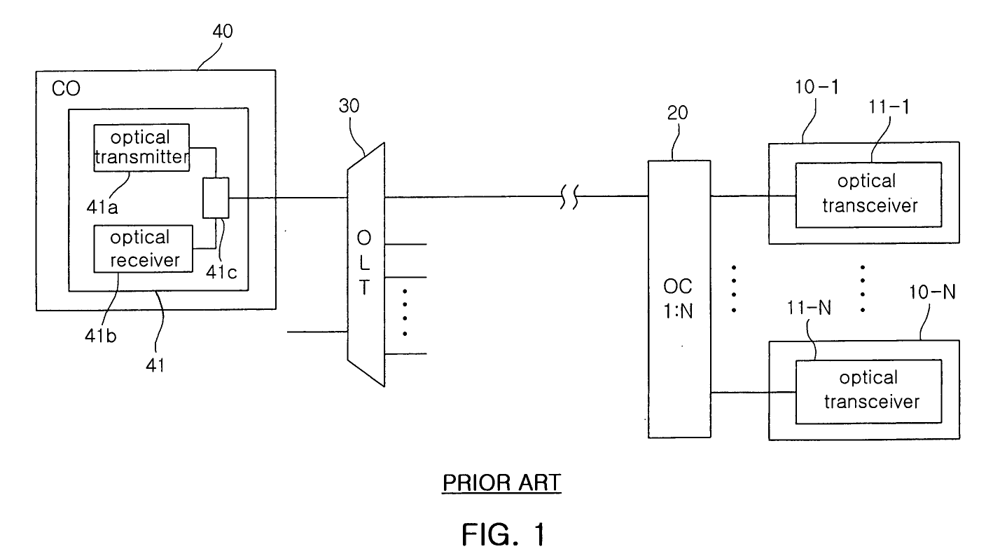

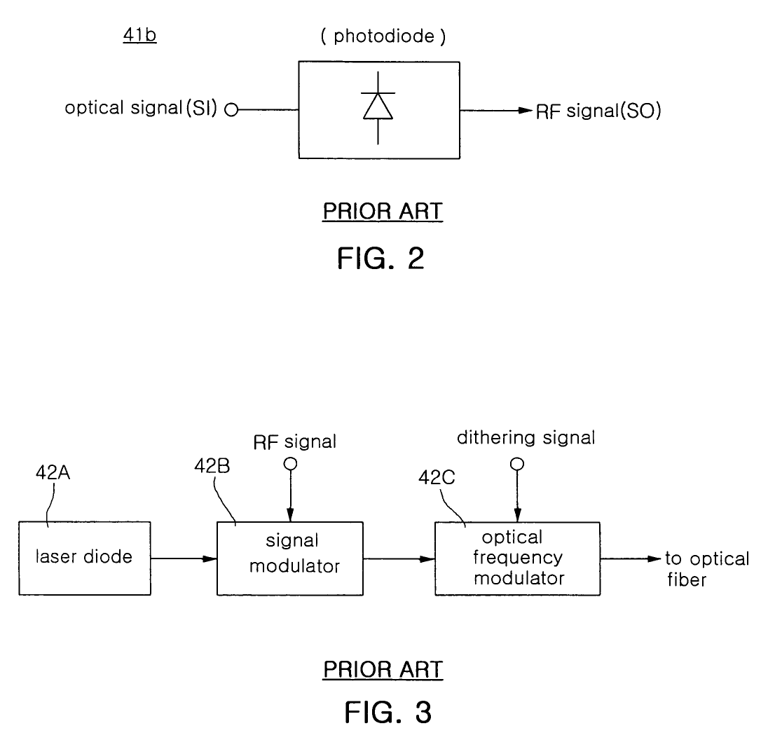

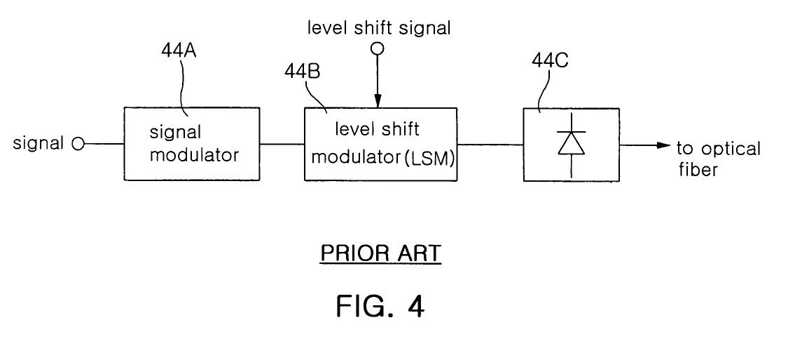

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

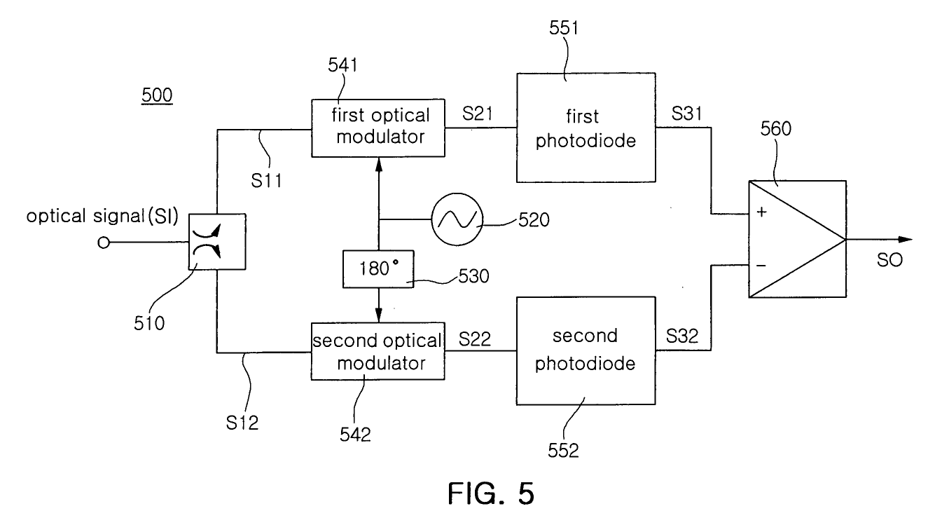

FIG. 5 is a block diagram illustrating an optical receiver in accordance with the present invention.

Referring to FIG. 5, an optical receiver 500 is applied to a CO contained in an ON such as a Passive Optical Network (PON).

The optical receiver 500 includes an optical power divider 510 for dividing an input optical signal (SI) into first and second optical signals S11 and S12; a frequency generator 520 for generating a predetermined oscillation frequency; a phase shifter 530 for shifting a phase of an oscillation frequency generated by the frequency generator 520; a first optical modulator 541 for modulating the first optical signal S11 with the oscillation frequency generated by the frequency generator 520; a second optical modulator 542 for modulating the second optical signal S12 with the oscillation frequency phase-shifted by the phase shifter 530; a first photodiode 551 for converting the optical signal S21 modulated by the first optical modulator 541 into an RF signal S31; a second photodiode 552 for converting the optical signal S22 modulated by the second optical modulator 542 into an RF signal S32; and a differential amplifier 560 for differentially amplifying the RF signal S31 generated by the first photodiode 551 and the RF signal S32 generated by the second photodiode 552, and canceling two optical beat interferences having the same phase, contained in each of the RF signals S31 and S32.

The length of an optical signal transmission channel from the optical power divider 510 to the first photodiode 551 is equal to the length of the other optical signal transmission channel from the optical power divider 510 to the second photodiode 552. The first photodiode 551 has the same characteristics as the second photodiode 552.

Preferably, the optical power divider 510 may divide the optical signal SI into the first and second optical signals S11 and S12 having the same power.

Preferably, the frequency generator 520 may have a frequency higher than that of an RF signal contained in the optical signal.

Preferably, the phase shifter 530 may shift a phase of the oscillation frequency generated by the frequency generator 520 by a predetermined angle of 180°.

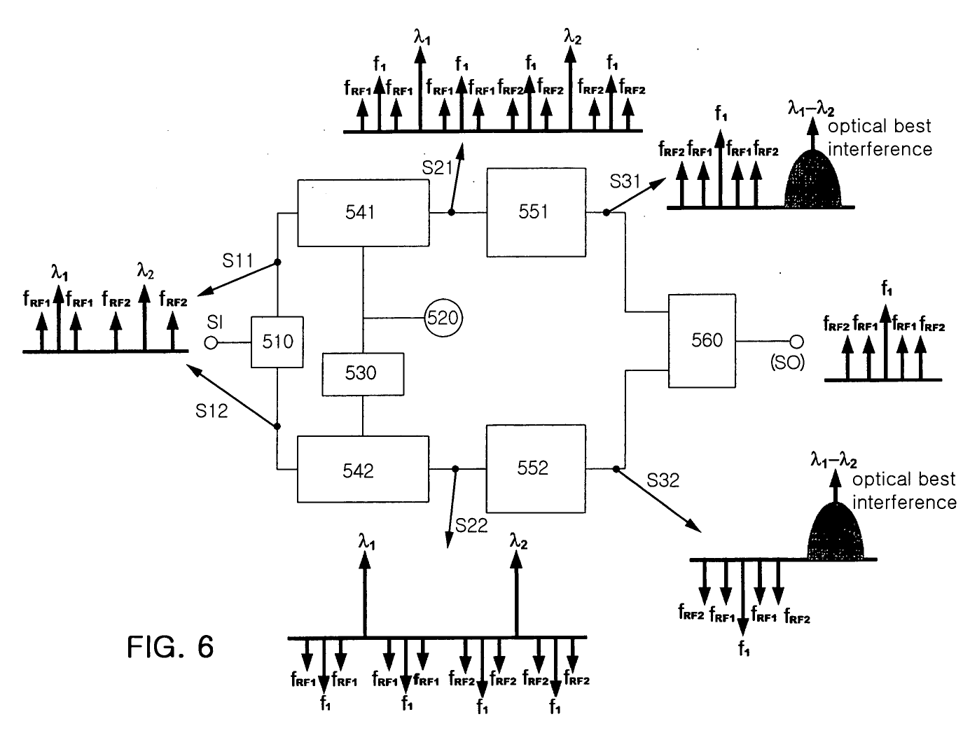

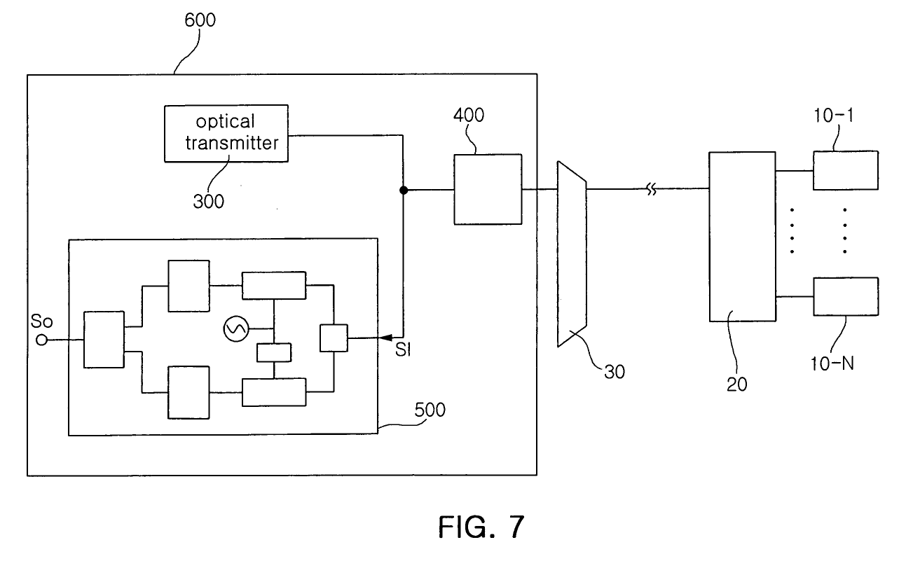

FIG. 6 is a view illustrating spectrums of the principal signals shown in FIG. 5 in accordance with the present invention.

Referring to FIG. 5, the optical signals S11 and S12 are indicative of the first and second optical signals generated when the input optical signal SI is divided by the optical power divider 510, respectively. The optical signals S11 and S12 are indicative of optical signals for loading a plurality of RF signals f_{RF1} and f_{RF2} on a plurality of optical wavelengths λ1 and λ2. The optical signals S21 and S22 are indicative of signals modulated by the first and second optical modulators 541 and 542, respectively. The optical signals S21 and S22 are indicative of optical signals for loading a plurality of RF signals f_{RF1} and f_{RF2} and an oscillation frequency f1 on a plurality of optical wavelengths λ1 and λ2. In this case, the RF signals include data therein. The optical signals S31 and S32 are indicative of RF signals in which a plurality of optical wavelengths are deleted by the first and second photodiode 551 and 552. The optical signals S31 and S32 each include an RF signal, an oscillation frequency f1, and an optical beat interference. The signal SO is indicative of an output signal of the differential amplifier 560, and includes an RF signal and an oscillation frequency f1.

FIG. 7 is a block diagram illustrating an ON including the optical receiver in accordance with the present invention. Referring to FIG. 7, the ON of the present invention includes a plurality of subscriber ends 10-1 to 10-N including individual optical transceivers, respectively; a first optical coupler 20 connected to the subscriber ends 10-1 to 10-N via individual optical fibers; an OLT 30 connected to the first optical coupler 20 via a single optical fiber; an optical transmitter 300 for converting an RE signal to be transmitted into an optical signal; a second optical coupler 400 for receiving the optical signal from the optical transceiver 300, and transmitting the received optical signal to the optical fiber connected to the OLT 30; and an optical receiver 500 for receiving the optical signal from the second optical coupler 400, and converting the received optical signal into an RF signal.

In this case, the optical transceiver 300, the second optical coupler 400, and the optical receiver 500 are contained in the CO 600. A detailed configuration of the optical receiver is shown in FIG. 5.

Operations and effects of the present invention will hereinafter be described with reference to the annexed drawings.

The optical receiver and the ON for use in the present invention will hereinafter be described with reference to FIGS. 5-7. In FIG. 5, the optical receiver 500 is applied to the CO 600 included in an ON such as a PON, and removes optical beat interference generated by interference between optical wavelengths during the optical signal detection period indicative of a period during which the received optical signal is converted into an electric RF signal.

The optical receiver 500 will hereinafter be described with reference to FIG. 5.

Referring to FIG. 5, the optical power divider 510 contained in the optical receiver 500 divides the input optical signal SI received via an optical fiber into first and second optical signals S11 and S12. In this case, a 1:1 optical power divider is applied to the optical power divider 510, such that the optical signal SI is divided into the first and second optical signals S11 and S12 having the same optical power.

As shown in FIG. 6, the input optical signal SI and the first and second optical signals S11 and S12 are indicative of optical signals having the same magnitude and phase. The first and second optical signals S11 and S12 each include a plurality of RF signals f_{RF1} and f_{RF2} in individual optical wavelengths λ1 and λ2.

The frequency generator 520 contained in the optical receiver 500 generates a predetermined oscillation frequency, and outputs the generated oscillation frequency to the first optical modulator 541. Preferably, the frequency generator 520 generates a frequency higher than that of the RF signal contained in the optical signal SI. For example, provided that each of the RF signals f_{RF1} and f_{RF2} contained in the optical signal SI are determined to be about 100 MHz, the oscillation frequency may be determined to be about 200 MHz, due to a specific optical modulation characteristic indicating that optical modulation is facilitated on the condition that the oscillation frequency indicative of a modulation signal must be higher than that of the RF signals including data. The above-mentioned optical modulation characteristic is well known in the art.

The phase shifter 530 contained in the optical receiver 500 shifts a phase of the oscillation frequency generated by the frequency generator 520, and outputs the shifted result to the second optical modulator 542. In this case, the phase shifter 530 must shift the phase of the oscillation frequency generated by the frequency generator 520 by about 180°. Particularly, in order to perform more accurate differential amplification of the RF signal, the phase shifter 530 must correctly shift the phase of the oscillation frequency by 180°.

Thereafter, the first optical modulator 541 contained in the optical receiver 500 modulates the first optical signal S11 with the oscillation frequency generated by the frequency generator 520. Also, the second optical modulator 542 modulates the second optical signal S12 with the oscillation frequency phase-shifted by the phase shifter 530. During the above-mentioned modulation process, the RF signal included in the optical signal increases its own frequency by an oscillation frequency received while passing through the first and second optical modulators 541 and 542, and the resultant RF signal is re-included in the optical signal.

In this case, the signal S21 modulated by the first optical modulator 541 and the other signal S22 modulated by the second optical modulator 542 in the optical receiver 500 include two optical signals λ1 and λ2 having the same phase and magnitude as shown in FIG. 6. However, the RF signals f_{RF1} and f_{RF2} and the oscillation frequency f1, which are included in the optical signals λ1 and λ2, have opposite phases and the same magnitude.

In more detail, the first and second optical modulators 541 and 542 perform a specific function equal to that of an RF mixer. In the case of comparing a first RF signal, which is included in an optical signal generated from the second optical modulator 542 to which an oscillation frequency generated from the phase shifter 530 is applied, with a second RF signal, which is included in the optical signal generated from the first optical modulator 541 to which an oscillation frequency of the frequency generator 520 is directly applied without passing through the phase shifter 530, it can be recognized that the first and second RF signals have the same magnitude whereas they have opposite phases.

The first photodiode 551 contained in the optical receiver 500 converts the optical signal S21 modulated by the first optical modulator 541 into an RF signal, such that optical wavelength components λ1 and λ2 are removed from the optical signal S21 and the RF signals f_{RF1} and f_{RF2} and the oscillation frequency f1 are generated from the first photodiode 551.

The second photodiode 552 contained in the optical receiver 500 converts the optical signal S22 modulated by the second optical modulator 542 into an RF signal, such that optical wavelength components λ1 and λ2 are removed from the optical signal S22 and the RF signals f_{RF1} and f_{RF2} and the oscillation frequency f1 are generated from the second photodiode 552.

In the case of comparing the output signal S31 of the first photodiode 551 with the output signal S32 of the second photodiode 552, it can be recognized that the RF signals f_{RF1} and f_{RF2} and the oscillation frequency f1, that are contained in individual signals S31 and S32, have the same magnitude whereas they have opposite phases, as shown in FIG. 6.

In the meantime, when the first photodiode 551 and the second photodiode 552 each convert the optical signal into an RF signal, optical beat interference generated by interference between optical wavelengths λ1 and λ2 may be included in the RF signal as shown in FIG. 6. For example, M optical signals are simultaneously detected by individual photodiodes. Based on characteristics of the photodiodes capable of detecting only the magnitude of the optical signals, M optical signals and M(M-1) optical beat interferences are generated by interference among the optical signals. If the above-mentioned optical beat interferences are generated in individual frequency bandwidths of RF signals to be detected, they deteriorate an SNR of a transmission signal.

In this case, it can be recognized that first optical beat interference contained in the output signal S31 of the first photodiode 551 has the same phase and magnitude as those of the second optical beat interference contained in the output signal S32 of the second photodiode 552.

Particularly, the length of an optical signal transmission channel from the optical power divider 510 to the first photodiode 551 is equal to the length of the other optical signal transmission channel from the optical power divider 510 to the second photodiode 552. Also, the first photodiode 551 has the same characteristics as the second photodiode 552, such that optical beat interferences have the same magnitude and phase.

The differential amplifier 560 of the optical receiver 560 differentially amplifies the RF signal S31 generated by the first photodiode 551 and the other RF signal S32 generated by the second photodiode 552, and cancels two optical beat interferences having the same phase, contained in each of the RF signals S31 and S32.

In this case, the differential amplifier 560 is characterized in that it outputs a difference between two input RE signals, such that individual optical beat interferences generated from the first and second photodiodes 551 and 552 have the same magnitude and phase. Therefore, the optical beat interferences are deleted by the differential amplifier 560, and constructive interference is applied to individual RF signals having the same phase and opposite phases by the differential amplifier 560, such that the constructive-interference result is generated from the differential amplifier 560.

In the case of applying the optical receiver of FIG. 5 to the CO 600 as shown in FIG. 7, the optical receiver 500 contained in the CO 600 is connected to a plurality of subscriber ends 10-1 to 10-N via a first optical coupler 400, OLT 30, and a second optical coupler 20, such that it can receive a plurality of optical signal from the subscriber ends 10-1 to 10-N without generating optical beat interference.

Therefore, the CO 600 can efficiently remove the optical beat interference, and can easily maintain and manage an optical network (ON).

As apparent from the above description, the present invention provides an optical receiver for allowing a CO for use in an ON such as a WPON or WDM-PON based on an SCMA scheme to remove optical beat interference generated when detecting a multiple light source signal by inverting a signal phase or using a differential amplifier, such that the CO can efficiently remove the optical beat interference, resulting in greater convenience of maintenance and management of the ON.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical receiver apparatus for use in a Central Office (CO) contained in an Optical Network (ON), comprising:
an optical power divider for dividing an input optical signal into first and second optical signals;
a frequency generator for generating a predetermined oscillation frequency;
a phase shifter for shifting a phase of an oscillation frequency generated by the frequency generator;
a first optical modulator for modulating the first optical signal with the oscillation frequency generated by the frequency generator;
a second optical modulator for modulating the second optical signal with the oscillation frequency phase-shifted by the phase shifter;
a first photodiode for converting the optical signal modulated by the first optical modulator into an RF signal;
a second photodiode for converting the optical signal modulated by the second optical modulator into an RF signal; and
a differential amplifier for differentially amplifying the RF signal generated by the first photodiode and the RF signal generated by the second photodiode, and canceling two optical beat interferences having the same phase, contained in each of the RF signals.

2. The apparatus according to claim 1, wherein:
the length of an optical signal transmission channel from the optical power divider to the first photodiode is equal to the length of the other optical signal transmission channel from the optical power divider to the second photodiode.

3. The apparatus according to claim 2, wherein the first photodiode and the second photodiode have the same characteristics.

4. The apparatus according to claim 3, wherein the optical power divider divides the optical signal into the first and second optical signals having the same power.

5. The apparatus according to claim 3, wherein the frequency generator generates a frequency higher than that of a Radio Frequency (RF) signal contained in the optical signal.

6. The apparatus according to claim 3, wherein the phase shifter shifts a phase of the oscillation frequency generated by the frequency generator by a predetermined angle of 180°.

7. An optical network (ON) comprising the optical receiver as set forth in any one of claims 1 to 6.
